(19) United States
(12) Patent Application Publication
(10) Pub. No.: US 2016/0153614 A1
(43) Pub. Date: Jun. 2, 2016

(54) TRANSPORTATION AND/OR STORAGE DEVICE COMPRISING A DOUBLE-WALLED INSULATING BULB

(71) Applicant: ST REPRODUCTIVE TECHNOLOGIES, LLC, Navasota, TX (US)

(72) Inventor: Eric Cognard, Fontenai Les Louvets (FR)

(73) Assignee: ST REPRODUCTIVE TECHNOLOGIES, LLC, Navasota, TX (US)

(21) Appl. No.: 14/903,075

(22) PCT Filed: Sep. 11, 2013
(86) PCT No.: PCT/US13/59261

§ 371 Date: Jan. 6, 2016

(30) Foreign Application Priority Data
Apr. 30, 2013 (FR) 13/53982

(51) Int. Cl. F17C 3/08; F17C 13/00

(52) U.S. Cl. CPC F17C 3/085; F17C 13/001; F17C 2260/01

(57) ABSTRACT

A transportation and/or storage device comprising a cap and an external packaging structure with curved outer contours and a double-walled insulating bulb. The invention can be used for transportation and/or storage of products conserved at very low temperatures by means of a liquefied fled gas, such as liquid nitrogen, and entails a reduced number of components, low manufacturing cost and permits single-use utilization.

This invention relates to a transportation and/or storage device comprising a cap and an external packaging structure with curved outer contours and a double-walled insulating bulb. The invention can be used for transportation and/or storage of products conserved at very low temperatures by means of a liquefied gas, such as liquid nitrogen, and entails a reduced number of components, low manufacturing cost and permits single-use utilization.

### BACKGROUND OF THE INVENTION

Cryostats are vessels widely used for transporting biological materials requiring conservation at a very low temperature, generally achieved through the use of a liquified gas such as liquid nitrogen. Cryostats typically comprise an insulating bulb consisting of two metal walls separated by a void. A connecting ring in the area of the neck of the bulb connects the internal and external walls of the bulb.

Cryostats have a number of drawbacks associated with their use, however. First, the use of metal materials to manufacture such cryostats entails a high manufacturing cost and precludes single-use application. Second, the use metal materials also results in comparatively high shipping cost due to weight. Third, cryostats are generally not very stable because they typically have a bottom that is smaller in proportion to their height, giving them a high center of gravity and making them easy to tip. Fourth, cryostats are also particularly vulnerable to shocks, to damage caused by falling during transport, and to an overall increased risk of damage due to their lack of stability.

Specifically, in the event of a shock or fall, forces are directly received by the outer wall of the insulating bulb and are transmitted to the connecting ring. Such forces often cause the connecting ring to rupture, which can be extremely harmful to the transported products because the vacuum between the walls is lost, causing the cryostat to lose its insulating properties. In addition to external forces that stem from shocks or falls sustained by the cryostat, additional forces in the opposite direction of the initial shock are transmitted to the inner wall of the bulb by its contents. The combination of these forces on the inner and outer walls of the bulb place even more stress on the connecting ring.

### SUMMARY OF THE INVENTION

One possible solution to the problems mentioned above, is to pack the cryostat in a packaging structure in such a way as to protect it from direct shocks; however, such a solution also contributes to increasing both the manufacturing and usage costs of such cryostats, and the total transported weight. Furthermore, the risk of severely damaging the connecting ring cannot be completely eliminated and persists particularly in the event of a severe shock or a fall because the resulting forces are directly transmitted by the packaging structure to the metal outer wall of the cryostat.

The invention proposes various embodiments for a transportation and/or storage device to remedy the abovementioned shortcomings of the prior art. Some embodiments of the invention can be used for transporting and/or storing products, comprising an improved cryostat having an external packaging structure comprising walls defining an internal volume within which is a double-walled insulating bulb whose body is formed by an outer wall and an inner wall defining an internal volume, the bulb comprising an upper neck defining an upper filling opening, the device comprising an attachment structure that comprises bendable lugs capable of engaging with the only inner wall of the bulb in order to vertically suspend the bulb by its neck in such a way that the bulb hangs freely in the empty space inside the internal volume defined by the packaging structure, with no contact between the outer wall of the bulb and the walls of the packaging structure. The term “product” or “products” as used herein can include, but is not limited to, a liquefied gas, including liquid nitrogen as well as biological products, such as gametes, embryos, viruses, bacteria, protozoa, organs, cells or any other living material, whether in a frozen or unfrozen state.

In the embodiments that comprise a double-walled glass bulb, the manufacturing cost of is very low in comparison with metal-walled cryostats and more feasible for commercial applications. However, the bulb used with the device can be made out of any material including but not limited to glass, plastic, a polymer, stainless steel, plexiglass, fiberglass and polystyrene.

The suspension of the bulb by its neck through an attachment structure capable of engaging only with the inner wall of the bulb makes it possible to reduce the risk of severe damage to the bulb in case of shocks or falls. As a result of the attachment by suspension of the bulb, the outer wall of the bulb is completely free from any contact, particularly with the walls of the external packaging structure, in such a way that the risks of rupturing the neck of the bulb and losing the insulation in the event of shocks or falls are reduced to a great degree.

Furthermore, the use of a suspended double-walled glass bulb makes it possible to achieve a transportation device with a low manufacturing cost and low weight, capable of being used for a single usage, the external packaging structure of which is, for example, made of plastic or polymer material. The external packaging structure of the invention is capable of sustaining a local indentation, without inducing contact with the bulb, since there is an empty space between the outer wall of the bulb and the external packaging structure. Furthermore, in comparison with a very rigid metal structure, this deformation capacity tends to further reduce the forces transmitted to the bulb since the structure is capable of absorbing it through deformation.

Furthermore, some embodiments of the instant invention improve on the prior art devices in that the spherical shape of the external packaging of these embodiments provides additional protection for the glass bulb. In contrast to these spherically shaped embodiments, the external packaging structures of the prior art are generally cylindrical in shape. However, the flexibility of impact areas is much more heterogeneous on a cylinder compared to a sphere, which reduces the potential for protection of the insulating glass bulb within the packaging. Thus, the instant invention substantially increases the impact resistance of the double-walled glass bulbs thanks to a protective external packaging structure in a generally spherical configuration, as described in more detail below.

The invention consists of a transportation and/or storage device for liquefied gas such as liquid nitrogen. In certain embodiments of the invention, the device consists of an outer cap with a generally spherical shape and an external packaging structure having a curved outer contour. In further embodiments, the device also includes a double walled insulating bulb. In other embodiments, the device also comprises an attachment structure for suspending the bulb. In yet other embodiments, the device also comprises an annular sleeve that is radially interposed between the attachment structure and the inner wall of the bulb. In yet other embodiments, the device further comprises a bottom wall that mates with the external packaging structure. And in yet other embodiments, the device can comprise a pad that is interposed between outer wall of the bulb and the inner surface of the bottom wall.

In certain embodiments, it is contemplated that the cap, the canister, the attachment structure, the bottom wall and the external packaging structure are formed of plastic or polymer material. The pad and annular sleeve can be formed of plastic or polymer, including foam, material as well as natural rubber. In further embodiments, the components of the invention can be manufactured using any known manufacturing method known in the art including but not limited to extrusion, blow molding, cutting, injection molding and thermoforming. In certain embodiments, the cap and the external packaging structure are formed by extrusion and blow molding. In other embodiments, the canister is formed by extrusion, blow molding and cutting. In further embodiments, the attachment structure is formed by injection molding. In yet further embodiments, the bottom wall is formed by thermoforming.

In some embodiments, the upper part of the external packaging structure consists of a tubular neck stiffened by support lugs. In certain embodiments, the neck is structured so as to allow locking with the cap by a bayonet system. Once assembled, the geometry of the curved external packaging structure and spherically shaped cap prevents the neck from being directly exposed to the impact of a fall.

In some embodiments, the attachment of the bulb to the external packaging structure is achieved by an attachment structure having a tubular shape with a flared shoulder at one end that fits into the neck of the packaging structure and bendable lugs on the other end. The attachment structure extends at least partially through the upper opening of the bulb and defines an orifice leading into the internal volume of the bulb. The attachment structure is inserted into the bulb at least until the bendable lugs have the ability to move radially outward to bear against the inner wall of the bulb. In some embodiments, the downwards vertical introduction of the tubular canister into the orifice of the attachment structure forces the bendable lugs to be maintained in the radially outward position.

In some embodiments, the canister has at its upper end a radial flange below which a tubular body comprising at least one hole extends vertically to allow the passage of fluid when filling the internal volume of the bulb.

In some embodiments, a flat bottom wall mates with the external packaging structure along the bottom of the packing structure and serves as a bottom wall. In further embodiments, a pad that fits within an indentation in the bottom wall is interposed between the inner surface of the bottom wall and the outer wall of the bulb and serves to support the bulb and dampen oscillation of the bulb when the shipping container is fully assembled.

In some embodiments of the invention comprises a device for transporting and/or storing products comprising an external packaging structure comprising a wall portion connecting a bottom wall to a neck, wherein the neck comprises an upper opening. In some embodiments of the invention, the wall portion may comprise a single unitary uninterrupted, unfolded surface. In further embodiments, the invention can further comprise an insulating bulb suspended within the external packaging structure, the insulating bulb comprising an upper neck and a body formed from an inner wall and an outer wall enclosing an internal volume. The neck of the external packaging structure may comprise an external surface, an upper most rim, and an opening with an inner diameter, wherein inner diameter of the upper opening is smaller than the insulating bulb. Finally, in some embodiments, the invention may comprise an attachment structure operatively connected to the interior of the neck and the exterior of the packaging structure to suspend the bulb within the external packaging structure. The attachment structure allows the passage of materials from the exterior of the external packaging structure into the insulating bulb while suspended.

In some embodiments of the invention, the wall portion of the external packaging structure comprises a vertical profile which is generally perpendicular to the bottom wall, wherein at least a portion of the vertical profile is circular, elliptical, parabolic or hyperbolic in shape. In a further embodiment, this vertical profile comprises an upper portion and a lower portion, and in yet a further embodiment, the curvature of the upper portion and lower portion of the vertical profile are different.

In some embodiments of the invention, the external packaging structure defines a central axis and the external packaging structure is generally radially symmetric around the central axis. Furthermore, a horizontal cross section of the external packaging structure, which is generally parallel to the bottom wall of the device, decreases in area moving from the bottom wall to the neck along the central axis.

In other embodiments, the attachment structure further comprises a plurality of outward facing external bendable lugs, wherein the bendable lugs are capable of radial movement between a retracted position and an extended position. The bendable lugs may be configured such that they clear the opening in the external packaging neck in the retracted position for entry into the bulb neck and wherein the bendable lugs engage the inner wall of the bulb for suspending the bulb when in their extended position. In further embodiments, a canister inserted into the attachment structure displaces the bendable lugs from their retracted position to their extended position.

Some embodiments of the invention can further comprise a cap configured for attachment to the external packaging structure and for covering the orifice, wherein at least a portion of the cap comprises a generally circular, elliptical, parabolic, or hyperbolic vertical profile.

### SUMMARY OF THE FIGURES

FIG. 1 is a lateral view of the fully assembled device of an embodiment of the invention showing the curved outer contours of the wall portion of the external packaging structure and the cap;

FIG. 2 is a view depicting a longitudinal cross-section of the fully assembled invention showing the manner in which the bulb is suspended within the external packaging structure using the attachment structure;

FIG. 3 is a perspective view of the neck and the wall portion of the external packaging structure;

FIGS. 4 and 5 are perspective views of the cap and the neck portion of the external packaging structure demonstrating the manner in which a bayonet within the cap interfaces with the rim and lugs on the neck portion of the external packaging structure so as to lock the cap in place;

FIG. 6 is an expanded view depicting an example of execution of a transportation and/or storage device according to certain embodiments of the invention, prior to assembly of the main components;

FIG. 7 is a perspective view of the internal structure of the cap;

FIGS. 8 and 9 are perspective views of the attachment structure of the device;

FIG. 10 is a perspective view of the canister of the device;

FIGS. 11 and 12 are perspective views of the bottom wall of the device;

FIGS. 13 and 14 are perspective views of the external packaging structure; and

FIG. 15 is a view depicting a longitudinal cross-section of an embodiment of the fully assembled invention.

FIG. 16 is a perspective view of an embodiment of the bottom wall of the device.

### DETAILED DESCRIPTION OF THE INVENTION

In the description and the claims, the following terms are used in a non-limiting manner and conventionally: the terms “upper” and “lower” and the orientations “lengthwise,” “vertical” and “transversal” to respectively designate the elements according to the definitions provided in the description and in relation to the trihedron (L, V, T) depicted on the figures.

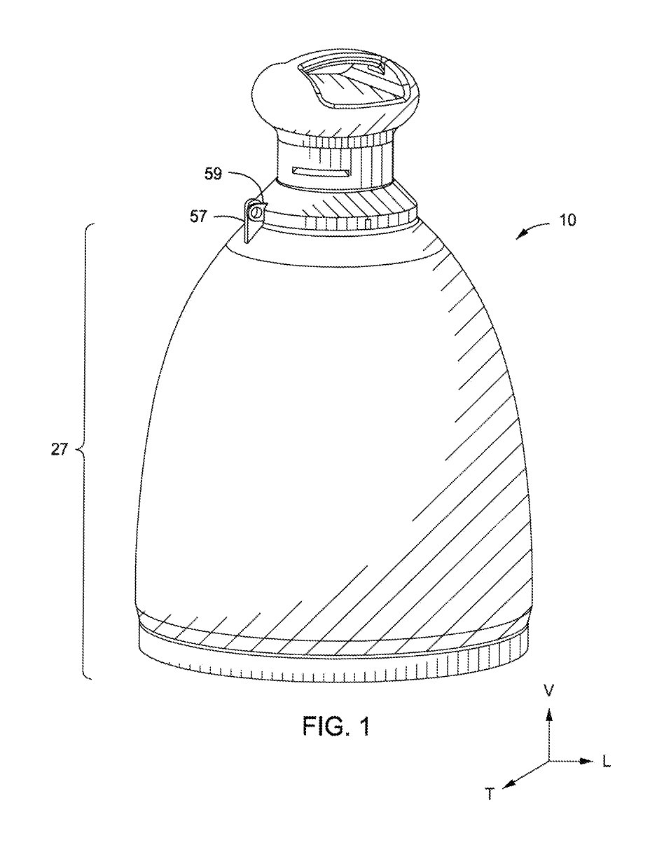

FIG. 1 shows an embodiment of the transportation and/or storage device 10 according to the invention. In this embodiment, the device 10 is used as a product storage and/or transportation device for use with liquefied gas. The device 10 according to some embodiments of the invention is not exclusively intended for the transport and/or storage of biological or other products, but is also capable of being used for the transport and/or storage of a liquefied gas itself. In certain embodiments, the device 10 is capable of being used for either of these uses, that is to say, in order to store a product or a liquefied gas, such liquid nitrogen, before and/or after its transport.

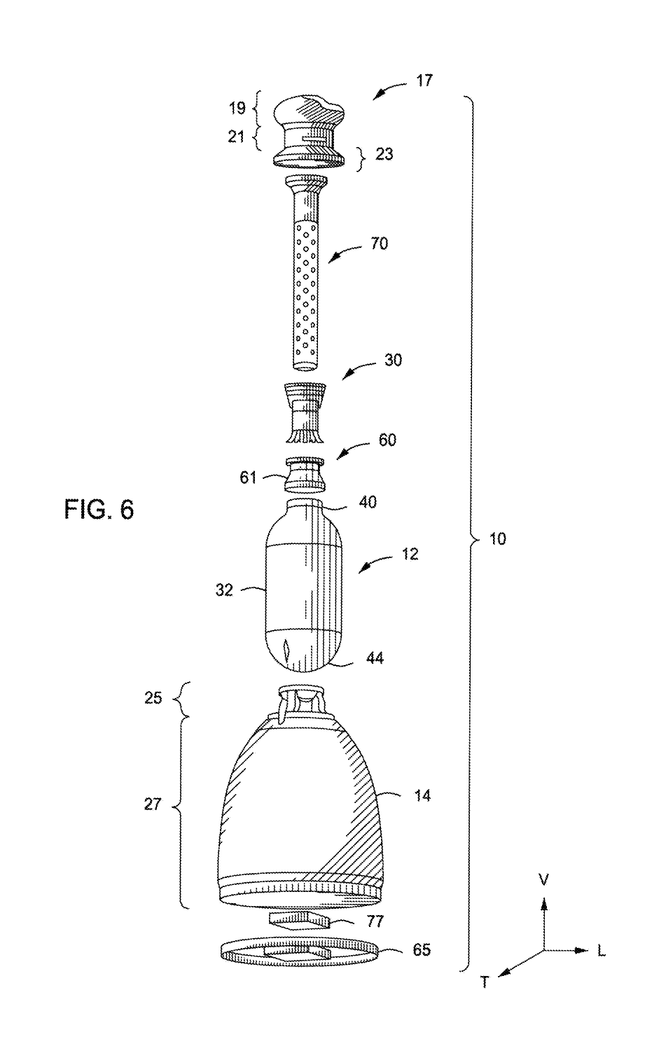

Referring to FIG. 6, the transportation and/or storage device 10 of this particular embodiment comprises a double-walled insulating bulb 12 that can be made of glass, and an external packaging structure 14.

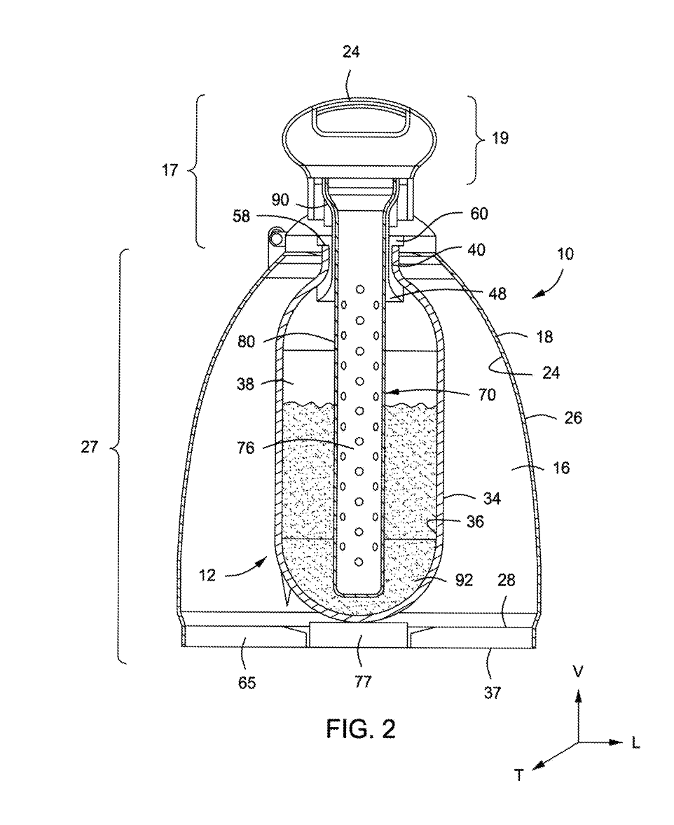

Referring to FIG. 2, the external packaging structure 14 consists of a wall 18 defining an internal volume 16 inside which is an insulating bulb 12 arranged in the mounted position of the transportation and/or storage device 10. As seen in FIG. 6, in at least one embodiment of the invention, the external packaging structure 14 also comprises a neck portion 25 that interfaces with a cap 17 and an attachment structure 30.

FIG. 6 shows the components of one of the embodiments of the invention in which the external packaging structure 14 is comprised of a wall portion 27 and a neck portion 25. The wall portion 27 is comprised of a single smooth wall 18, i.e. there is an absence of edges when viewed from the lateral view. Furthermore, when viewed from the lateral position as in FIG. 1, the outer contour of the wall portion 27 is in the general shape of a circle, ellipse, parabola or hyperbola or a partial circle, ellipse, parabola or hyperbola. Stated another way, a vertical cross-section of wall portion 27 is in the general shape of a circle, ellipse, parabola or hyperbola or a partial circle, ellipse, parabola or hyperbola as seen in FIG. 2. Stated yet another way, the wall portion 27 comprises a vertical profile that is generally perpendicular to the bottom wall of the device 10 and at least a portion of the vertical profile is circular, elliptical, parabolic or hyperbolic in shape. Additionally, the wall portion 27 is generally circular when viewing the horizontal, or axial, cross-section of the external packaging structure 14, but could also be elliptical in shape (not depicted).

As seen in FIG. 6, in certain embodiments, the cap 17 comprises a top portion 19, a cylindrical or tubular neck portion 21 and a flange portion 23. Referring to FIG. 2, when viewed from the lateral position, the outer contour of the top portion 19 is in the general shape of a circle, ellipse, parabola or hyperbola or a partial circle, ellipse, parabola or hyperbola. Stated another way, a vertical cross-section of top portion 19 is in the general shape of a circle, ellipse, parabola or hyperbola or a partial circle, ellipse, parabola or hyperbola. Stated yet another way, at least a portion of the cap 17 comprises a generally circular, elliptical, parabolic or hyperbolic vertical profile. The neck portion 21 of the cap 17 interfaces with the neck portion 25 of the external packaging structure 14, while the flange portion 23 of the cap 17 abuts the top of the wall portion 27 of the external packaging structure 14 thereby serving to provide a seal or barrier against external contaminants and to prevent spillage of internal contents. The top portion 19 of the cap 17 can also optionally comprise a carry handle 24 (see FIG. 2), which can be used to carry the transportation device in its fully assembled configuration.

In some embodiments, the cap 17 has a vertical height of 15 cm; in other embodiments, the cap 17 has a vertical height in the range of 10-20 cm. In some embodiments, the flange portion 23 of the cap 17 has a horizontal width of 14.2 cm; on other embodiments, the flange portion 23 of the cap 17 has a horizontal width in the range of 10-20 cm. In some embodiments, the neck portion 21 of the cap 17 has a horizontal width of 9.8 cm; in other embodiments, the neck portion 21 of the cap 17 has a horizontal width in the range of 5-15 cm.

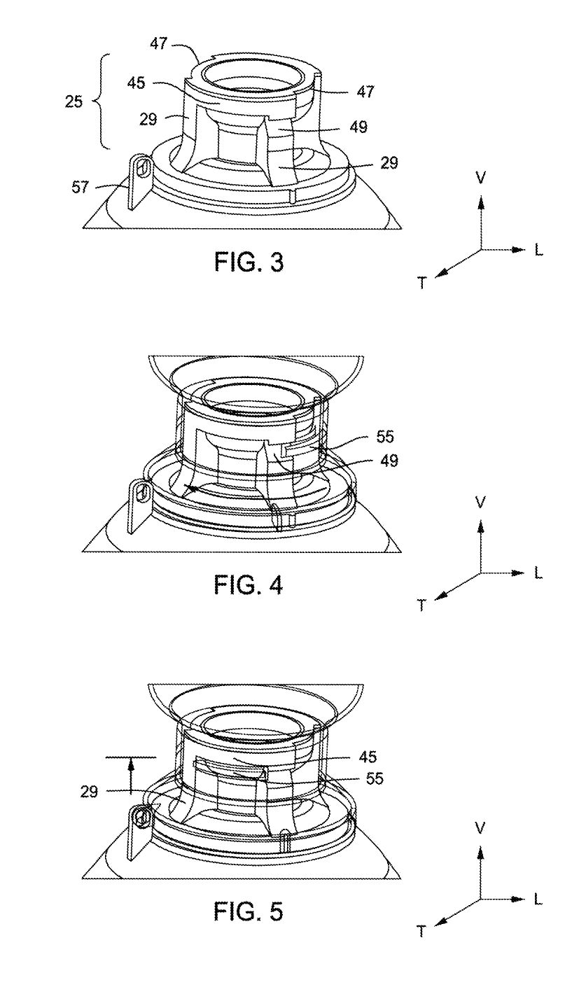

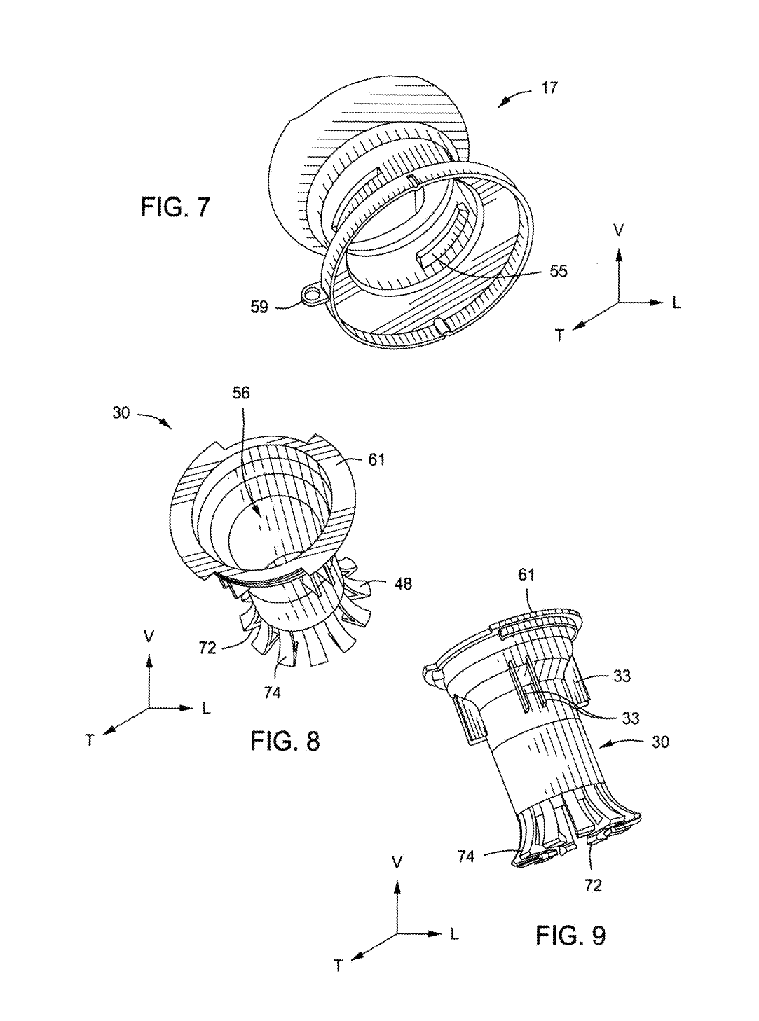

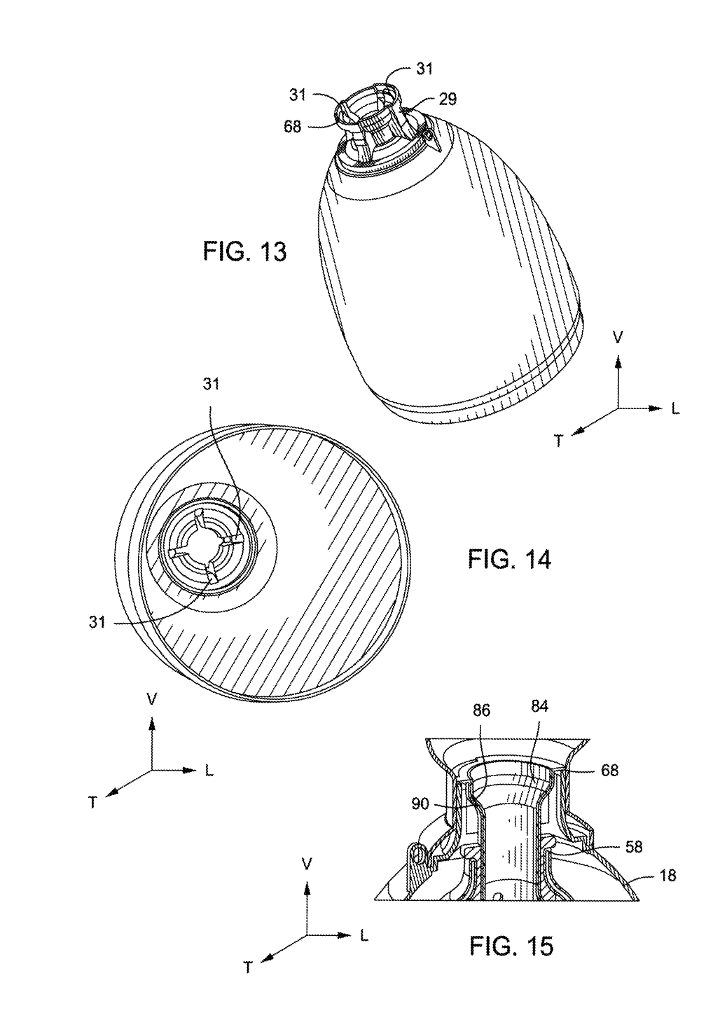

Referring to FIG. 3, in certain embodiments of the invention, the neck portion 25 of the external packaging structure 14 comprises one or more vertically oriented lugs 29, or struts, to reinforce the neck portion 25. The lugs 29 are arrayed around the opening of the neck portion. As depicted in FIGS. 13 and 14, the lugs 29, if hollow, can also optionally form slots 31 for receiving one or more vertically oriented tabs 33 on the attachment structure 30 (see FIGS. 8 and 9). Referring to FIG. 3 the neck portion 25 can also comprise a rim or shelf 45 connecting the upper portion of the lugs 29. The rim 45 can further comprise an indentation 47 allowing one or more bayonets or lugs 55 on the inner surface of the cap 17 (see FIG. 7) to pass through when the cap 17 is lowered vertically onto the neck portion 25.

Once the bayonet 55 on the cap 17 passes through the indentation 47 on the rim 45, the cap 17 can be twisted, as depicted in FIG. 4. While the cap 17 is twisted, an indentation 49 on one or more lug 29 allows the bayonet 55 on the inner surface of the cap 17 to pass through until the bayonet 55 abuts the next lug 29 without an indentation 49 as depicted in FIG. 5.

In a particular embodiment, the indentation 49 on the lug 29 is lower than the indentation 47 on the rim 45. Thus, after twisting the cap 17 so as to cause the bayonet 55 to abut a lug 29 without an indentation 49, lifting the cap 17 slightly will cause the bayonet 55 to rise above the indentation 49 on the lug 29 and to abut the rim 45 thereby locking the cap 17 onto the neck portion 25 as depicted in FIG. 5. Thereafter the cap 17 will not be able to be twisted.

Referring to FIG. 3, the wall portion 27 of external packaging structure 14 can further comprise a tab 57 for receiving a lock, cable or tether. The cap 17 can also further comprise a tab 59 for receiving a lock, cable or tether as depicted in FIG. 7. Referring to FIG. 1, in one embodiment, the tab 57 on the wall portion 27 overlaps with the tab 59 on the cap 17, so that a lock, cable or tether can pass through both when the cap 17 is placed onto the external packaging structure 14.

Referring to FIG. 2, in the external packaging structure 14, wall 18 defines an inner face 24 and an outer face 26, and a bottom wall 65 comprises an upper horizontal face 28 and a lower horizontal face 37. The double-walled insulating bulb 12 comprises a body 32 (see FIG. 6) consisting of an outer wall 34 and an inner wall 36, which are more or less parallel and separated by a space. The inner wall 36 defines an internal volume 38 of the bulb 12.

In some embodiments, the external packaging structure 14 has a vertical height of 46.5 cm; in other embodiments, the external packaging structure 14 has a vertical height in the range of 40-50 cm. In some embodiments, the external packaging structure 14 has a horizontal width of 35.8 cm; in other embodiments, the external packaging structure 14 has a horizontal width in the range of 30-40 cm. In some embodiments, the neck portion 25 of the external packaging structure 14 has a horizontal width of 9.7 cm; in other embodiments, the neck portion 25 of the external packaging structure 14 has a horizontal width in the range of 8-10 cm.

As depicted in FIG. 2, in certain embodiments, the bulb 12 comprises an upper neck 40 defining an upper opening, specifically intended to permit the filling of the internal volume 38 of the bulb 12 with fluid. As shown in FIG. 6, the bulb 12 also comprises, vertically opposite the neck 40, a bottom 44 that is largely hemispherical here.

In certain embodiments, the device 10 comprises an attachment structure 30 for attaching bulb 12, which comprises bendable lugs 48 (depicted in FIGS. 8 and 9) capable of engaging, directly or indirectly, with sole inner wall 36 of the bulb to vertically suspend the bulb 12 by its neck 40 as depicted in FIG. 2. Thus, in a mounted position of the device 10, the bulb 12 hangs freely in the space within the internal volume 16 defined by the packaging structure 14, that is to say, without contact between the outer wall 34 of the bulb 12 and the walls of the packaging structure 14, particularly the inner wall 24, and the upper horizontal face 28 of the bottom wall 65.

In some embodiments, the external packaging structure 14, the cap 17 and the bottom wall 65 each exhibits an elastic deformation capacity determined and defined so as to permit, particularly in case of shock(s) or fall(s), a limited movement of the bulb 12 in the packaging internal volume 16, and in such a way that the outer wall 34 of the suspended bulb 12 does not contact the inner wall 24 of the external packaging structure 14.

As depicted in FIG. 8, in some embodiments, the attachment structure 30 is a tubular structure that comprises a flange 61 at its top end that contacts a shelf 68 on the inside of the neck portion 25 of the external packaging structure 14 (as depicted in FIG. 15), thereby supporting the attachment structure 30 within the external packaging structure 14. The attachment structure 30 can further comprise vertically oriented tabs 33 on its outer surface that fit into slots 31 in on the inside of the neck portion 25 of the external packaging structure 14, thereby preventing the rotation of the attachment structure 30 within the external packaging structure 14. The attachment structure 30 further comprises a plurality of bendable lugs 48 that are capable of radial movement away from the center axis of the attachment structure 30. These bendable lugs 48 contact the inner surface of an annular sleeve 60 that is radially interposed between the attachment structure 30 and the inner wall of the bulb 12.

The attachment structure 30 defines an orifice 56 (see FIG. 8) leading into internal volume 38 of bulb 12, which progressively flares out downwards from the upper edge 58, which constitutes the only area of connection between the outer 34 and inner 36 walls of the bulb 12. The device 10 can further optionally comprise a closing stopper or plug made of plastic or polymer, including foam, material that is capable of obturating the orifice 56 of the attachment structure 30.

In some embodiments, the attachment structure 30 has a vertical height of 13.5 cm; in other embodiments, the attachment structure 30 has a vertical height in the range of 10-15 cm. In some embodiments, the end of the attachment structure 30 comprising the bendable lugs 48 has an outer diameter of 5.2 cm; in other embodiments, the end of the attachment structure 30 comprising the bendable lugs 48 has an outer diameter in the range of 4-6 cm.

In some embodiments, the device 10 comprises an annular sleeve 60 (see FIG. 6) that, in the mounted position, is radially interposed between the attachment structure 30 comprising the bendable lugs 48 and the inner wall 36 of the bulb 12 located in the proximity of the flared neck 40 whose shape it follows as depicted in FIG. 2.

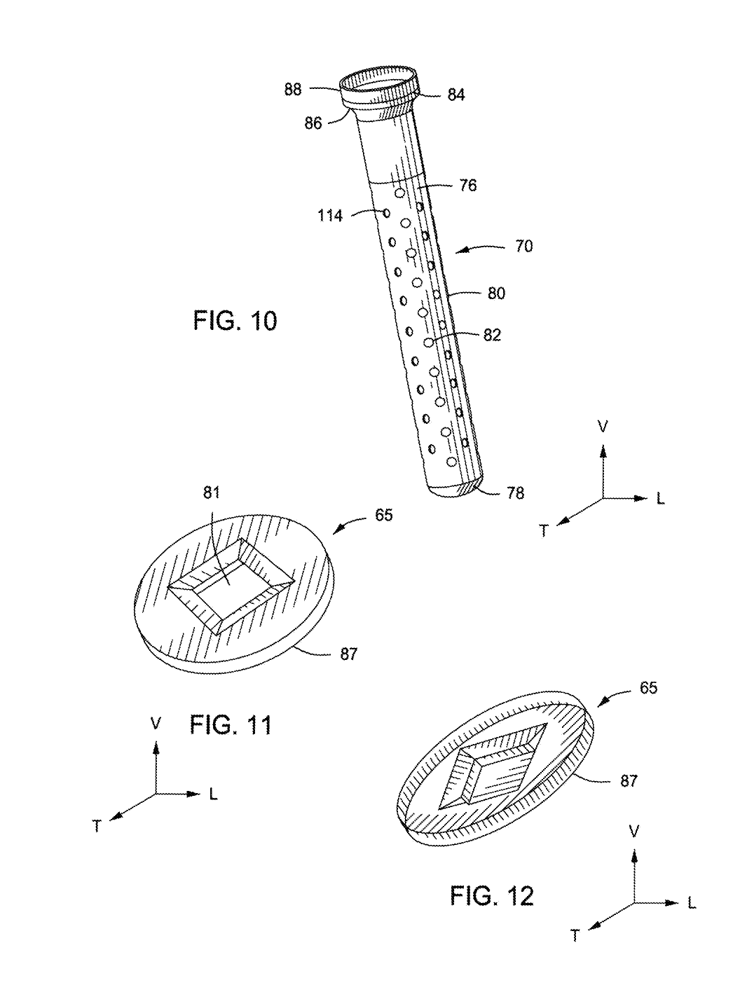

In certain embodiments, the device 10 comprises a canister 70 (see FIG. 10) whose vertical introduction, downwards into the orifice 56 of the attachment structure 30, is capable of causing the movement of bendable lugs 48 radially outward so as to suspend the bulb 12. The bendable lugs 48 are mounted in a movable manner on the attachment structure between a retracted position and an extended position and are, for example, regularly distributed circumferentially.

As shown in FIGS. 8 and 9, in some embodiments, each bendable lug 48 exhibits a general “L” shape and includes a canister portion 72 that contacts the canister 70 and a locking portion 74 that contacts annular sleeve 60. The radially outward movement of bendable lugs 48 from the retracted position to the extended position is accomplished by the vertical introduction downwards of canister 70, through upper orifice 56 of attachment structure 30.

Canister 70 comprises a tubular body 76 (see FIG. 10) of a diameter smaller than that of the orifice 56 of attachment structure 30 in such a way that when canister 70 is introduced axially, tubular body 76 engages with canister portion 72 of bendable lugs 48 and causes an approximately 45° pivoting of the bendable lugs 48 from the retracted position to the extended position.

As may better be seen on FIG. 2, tubular body 76 of canister 70 then immobilizes lugs 48 in a locking position in such a way that canister 70 constitutes a means of latching lugs 48 in the locking position. In fact, canister portion 72 of bendable lugs 48 then extend vertically along outer cylindrical wall 80 of tubular body 76 of canister 70.

In some embodiments, bendable lugs 48 extend obliquely in the extended position, so as to serve as a support against a face 61 opposite sleeve 60, which is integrated with inner wall 36 in the proximity of neck 40. In the mounted position, sleeve 60 is interposed radially between inner wall 36 of bulb 12 and the outside attachment structure 30 penetrating into bulb 12 in the area of neck 40.

As a variant, the device 10 does not comprise a sleeve 60 and lugs 48 engage directly in the locking position with the flared portion of inner wall 36 of neck 40 of bulb 12.

In some embodiments, canister 70 comprises a tubular body 76 whose lower end 78 is closed by a bottom, in an open variant, and whose cylindrical wall 80 is equipped with at least one hole 82 to permit the passage of fluid, specifically during filling as depicted in FIG. 10. In some embodiments, tubular body 76 comprises a plurality of holes 82 that are distributed circumferentially around cylindrical wall 80 and vertically over several superimposed rows among which holes 82 are laid out in a staggered fashion, from one row to another.

In some embodiments, canister 70 comprises at its upper end a generally “S” shaped flange 84 comprising a wall 86 that extends radially and slightly upward to the outside from the upper end of tubular body 76 of canister 70 and a vertical wall 88. In the mounted position (FIG. 15), the flange 84 of the canister 70 is supported by means of its wall 86 against a complementary shoulder 90 of attachment structure 30. In some embodiments, canister 70 extends vertically through internal volume 38, but without direct contact between its body 76 or its end 78 and inner wall 36 of bulb 12.

Optionally the device 10 comprises positioning means 92 (see FIG. 2) capable of maintaining the canister 70 during transport, here in the center position. The positioning means 92 particularly ensure a mechanical connection between the tubular body 76 of the canister 70 and the inner wall 36 of the bulb 12 in such a way that the forces that are capable of being transmitted in the event of a shock or fall are then advantageously distributed over the entire inner wall 36 of the bulb 12 and not only on the portion of the inner wall 36 in the area of the neck 40 and of the sleeve 60.

According to a non-depicted embodiment, the positioning means 92 consist of a ring whose outside diameter corresponds to the inside diameter of the bulb 12 and whose inside diameter corresponds to the tubular body 76 of the canister 70. In some embodiments, the positioning ring of the canister 70 is made of foam, such as so-called filtration foam, the aerated structure of which does not or only minimally affects the internal volume 38 of the bulb 12. Such a positioning ring can be used when the bulb 12 of the device 10 is intended to be used as a transportation and/or storage tank for a fluid, which then directly constitutes the transported and/or stored product. According to another embodiment, the positioning means 92 consist of means capable of absorbing the liquefied gas. In certain embodiments, the positioning and/or absorption means 92 are arranged in all or part of the internal volume 38 of the bulb 12, prior to introducing the canister 70, and, for example, consist of polyurethane foam or phenolic foam, in flakes or expanded form. Thanks to their absorption capacity, the positioning means 92 absorb the fluid at the time of the filling, like a liquid is absorbed by a sponge, and the fluid is subsequently no longer capable of spreading outside the bulb 12 during the transport. Such a transportation and/or storage device 10 is no longer affected by the regulatory restrictions imposed, particularly for air freight, on a cryostat-type container containing hazardous materials that can spill and the device 10 is therefore capable of being transported like any packaging, without particular restrictions. The absorption means can thus ensure in the device 10 the positioning of the canister 70 as well as the mechanical connection between the latter and the inner wall 36 of the bulb 12.

As shown in FIG. 10, the canister 70 may comprise ventilation means 114 intended to enable the evacuation of the gases progressively released by the liquefied gas during transport and/or storage. The upper ventilation orifices 114 permit the evacuation of gases released by the fluid that thus escape from the internal volume 38 to the outside while passing through the opening of the neck 40 of the bulb 12.

Optionally, the upper tubular part of the canister 70 is capable of receiving a so-called internal stopper (not depicted), which allows the ventilation of the bulb 12 by permitting the gases produced by the fluid to be evacuated to the outside. The stopper can also be capable of limiting the overflow of fluid outside the bulb 12 in the event that an excessive amount was to be introduced, voluntarily or not, in relation to the maximum absorption capacity of the positioning means 92. Such a stopper makes it possible, on the one hand, to limit the thermal exchanges between the internal volume 38 of the bulb 12 and the outside, and on the other hand, to prevent the formation of condensation in the proximity of the neck 40, due to the temperature differences between the inside and the outside of the bulb. The stopper can be comprised of a plastic or polymer, including foam, material.

In some embodiments, the canister 70 has a vertical height of 40.9 cm; in other embodiments, the canister 70 has a vertical height in the range of 30-50 cm. In some embodiments, the body 76 of the canister 70 has a horizontal width of 4.8 cm; in other embodiments, the body 76 of the canister 70 has a horizontal width in the range of 3-5 cm. In some embodiments, the end of the canister 70 with the flange 84 has a width of 7.2 cm; in other embodiments, the end of the canister 70 with the flange 84 has a width in the range of 5-10 cm.

The main stages necessary to implement the transportation and/or storage device 10 in order to attain the final mounted position illustrated in FIG. 2 will now be described. In some embodiments, the bulb 12 comprises absorbing and/or positioning means 92 that are introduced inside the volume 38 and the sleeve 60 mounted inside the neck 40. The transportation and/or storage device 10 can be assembled specifically by introducing the attachment structure 30 into the neck portion of the external packaging structure 14 and then introducing the attachment structure 30 into the neck 40 of the bulb 12. Once the attachment structure 30 is introduced, lugs 48 extend inside the bulb 12, but are in the retracted position; it is the vertical introduction of the canister 70 through the passage orifice 56 of the attachment structure 30 that causes the lugs 48 to pivot to their locking position. Once the canister 70 is introduced, the attachment structure 30 and the bulb 12 are then connected to one another through the lugs 48 that are maintained in a locked position by the canister 70. In some embodiments, the canister 70 is entirely introduced into the bulb 12, that is to say, until its flange 84 is received in the attachment structure 30 and the wall 86 engages with the shoulder 90. Finally, the bottom wall 65, with the pad 77 positioned under the bulb 12, is mated to bottom of the external packaging structure 14.

As shown in FIGS. 11 and 12, the bottom wall 65 is generally circular in shape when viewed from above and comprises an indentation 81 for receiving a pad 77 and a vertically oriented wall 87 around its periphery. The wall 87 can be press fit onto the base of wall portion 27 of the external packaging structure 14. Adhesive or any other known attachment compound or method known in the art can be used to further secure the bottom wall 65 to the wall portion 27 of the external packaging structure 14. The pad 77 (see FIGS. 2 and 6) can be made from plastic or polymer material, and in one embodiment is made from low-density polyethylene. In a particular embodiment of the invention, the pad 77 contacts the outer wall 34 of the bulb 12 when the device 10 is fully assembled, and in a more particular embodiment, the pad 77 contacts the bottom 44 of the bulb 12. The internal volume 38 of the bulb 12 is then filled, through the top, by pouring the fluid through the upper opening defined by flange 84 of the canister 70.

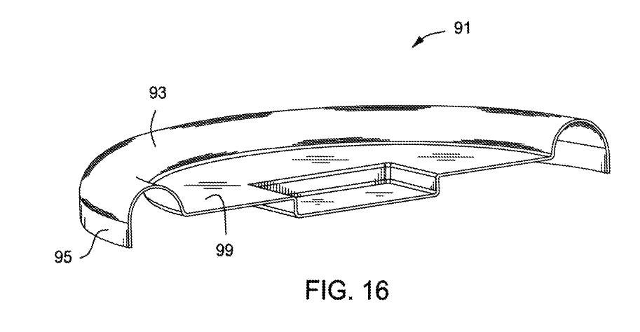

In another embodiment as shown in FIG. 16, a bottom wall 91 for use in the invention is generally circular in shape when viewed from above can comprise a curved portion 93 that connects a vertically oriented wall portion 95 of the bottom wall 91 to a horizontally oriented wall portion 99 of the bottom wall 91 along the outer perimeter of the horizontally oriented wall portion 99. The curved portion 93 adds flexibility to the bottom wall helping to further mitigate shock from impacts to the invention, especially lateral impacts.

In some embodiments, the bottom wall 65 has an outer diameter of 34 cm; in other embodiments, the bottom wall 65 has an outer diameter in the range of 30-40 cm; in yet other embodiments, the vertically oriented wall 87 of the bottom wall 65 has a vertical height of 2.5 cm; in other embodiments, the vertically oriented wall 87 of the bottom wall 65 has a vertical height of in the range of 1-4 cm.

In certain embodiments, the introduced fluid is completely absorbed by the absorption means 92. Once the filling is completed, the products to be transported and/or stored are, for example, introduced directly into the volume defined by the canister 70, which then constitutes a carrier tube

In a variant, the products are carried by a support pipe or cane (not depicted) that is vertically introduced from top to bottom inside the canister 70.

As previously noted, in certain embodiments, the upper part of the tubular body 76 of the canister 70 is capable of receiving a stopper, which permits the evacuation of the gases produced by the fluid outside the bulb, to limit the thermal exchanges and also to limit the discharge of fluid outside the bulb 12. In certain embodiments, the transportation and/or storage device 10 is capable of being closed to permit shipment of the product using cap 17.

In certain embodiments, the outer wall 34 is free from any contact and the mechanical forces transmitted in the case of shock(s) or fall(s) are only exerted on the inner wall 36 alone. In fact, the mechanical forces caused by shocks or a fall are, if necessary, transmitted to the inner wall 36 of the bulb 12, on the one hand, by the attachment structure 30, which engages, directly or through the intervention of the sleeve 60, with said inner wall 36 and, on the other hand, by the tubular body 76 via positioning means 92, absorbent or not. Thanks to the distribution of the forces over the entire inner wall 36, the risk of rupturing the neck 40 in the proximity of the connection area 58 between the outer 34 and inner 36 walls of the double-walled glass insulating bulb 12 in particular is eliminated.

In certain embodiments, the device 10 is used for the transport and/or storage of biological products, such as gametes or embryos, but may also be used for any product that needs to be conserved at very low temperature by a liquefied gas, such as liquid nitrogen. The transported or stored products can also comprise products such as viruses, vaccines, and medical samples intended to be analyzed, etc.

In certain embodiments, the device 10 is also capable of being used to transport and/or store a liquefied gas, such as liquid nitrogen, the internal volume of the bulb 12 constituting a tank for the liquid. In certain embodiments, the device 10 does not include absorbent-type positioning means 92 when it is used to transport or store a liquefied gas.

As can be easily understood from the foregoing, the basic concepts of the present invention may be embodied in a variety of ways. The invention involves numerous and varied embodiments of a transportation and/or storage device including, but not limited to, the best mode of the invention.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. Alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Moreover, for the purposes of the present invention, the term “a” or “an” entity refers to one or more of that entity. As such, the terms “a” or “an”, “one or more” and “at least one” can be used interchangeably herein.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice versa as necessary to define the matter for which protection is sought by this application or by any subsequent application or continuation, division, or continuation in part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation in part application thereof or any reissue or extension thereon.

1. A device for transporting and/or storing products comprising:
an external packaging structure comprising a wall portion connecting a bottom wall to a neck portion, wherein the neck portion comprises an upper opening and wherein the wall portion comprises a vertical profile that is generally perpendicular to the bottom wall, wherein at least a portion of the vertical profile is circular, elliptical, parabolic or hyperbolic in shape;
an insulating bulb suspended within the external packaging structure, the insulating bulb comprising an upper neck and a body formed from an inner wall and an outer wall enclosing an internal volume; and
an attachment structure operatively connecting the interior of the upper neck and the neck portion of the external packaging structure to suspend the bulb within the external packaging structure.

2. The device of claim 1, wherein the attachment structure allows the passage of materials from the exterior of the external packaging structure into the insulating bulb while suspended.

3. The device of claim 1, wherein the attachment structure is coupled to the interior of the upper neck of the bulb through a sleeve.

4. The device of claim 1, wherein the wall portion comprises a single unitary uninterrupted, unfolded surface.

5. The device of claim 1, wherein the external packaging structure further defines a central axis.

6. The device of claim 5, wherein the external packaging structure is generally radially symmetric around the central axis.

7. The device of claim 6, wherein a horizontal cross section of the external packaging structure , which is generally parallel to the bottom wall, decreases in area moving from the bottom wall to the neck portion along the central axis.

8. The device of claim 1, wherein the neck portion of the external packaging structure comprises an external surface, an upper most rim, and an upper opening with an inner diameter, wherein the inner diameter of the upper opening in the neck portion is smaller than an outer diameter of the insulating bulb.

9. The device of claim 1, wherein the bottom wall comprises a pad, wherein the pad is made from a plastic or polymer material.

10. The device of claim 1, wherein the attachment structure further comprises a plurality of outward facing external bendable lugs, wherein the bendable lugs are capable of radial movement between a retracted position and an extended position.

11. The device of claim 10, wherein the bendable lugs are configured to clear the opening in the neck portion when in the retracted position for entry into the upper neck of the bulb and wherein the bendable lugs abut, either directly or through a sleeve, the inner wall of the bulb for suspending the bulb when in the extended position.

12. The device of claim 11, further comprising a canister, wherein insertion of the canister into the attachment structure displaces the bendable lugs from their retracted position to their extended position.

13. The device of claim 1, further comprising a cap configured for attachment to the external packaging structure and for covering the upper opening in the neck portion, wherein at least a portion of the cap comprises a generally circular, elliptical, parabolic, or hyperbolic vertical profile.

14. The device of claim 13, wherein the cap comprises one or more bayonets on an internal surface of the cap wherein the one or more bayonets abut an upper most rim of the neck portion of the external packaging structure and a lug of the neck portion of the external packaging structure to retain the cap on the neck portion of the external packaging structure.

15. The device of claim 1, wherein the bottom wall comprises a curved portion that connects a vertically oriented wall portion of the bottom wall to a horizontally oriented wall portion of the bottom wall along the outer perimeter of the horizontally oriented wall portion.
